(19) United States
(12) Patent Application Publication
(10) Pub. No.: US 2006/0047399 A1
(43) Pub. Date: Mar. 2, 2006

(54) Method and device for setting a desired longitudinal deceleration or longitudinal acceleration

(76) Inventors: Heiner Messner, Kornwestheim (DE); Christian Sperrle, Farmington, MI (US); Eberhard Holl, Vaihingen (DE)

Correspondence Address: KENYON & KENYON, ONE BROADWAY, NEW YORK, NY, 10004, US

(21) Appl. No.: 10/517,507

(22) PCT Filed: Mar. 21, 2003
(86) PCT No.: PCT/DE03/00937

§ 371 Date: Jun. 28, 2005

(30) Foreign Application Priority Data
Jun. 11, 2002 (DE) 102 25 891.0

(51) Int. Cl. G06F 19/00

(52) U.S. Cl. 701/70; 701/79

(57) ABSTRACT

A method for setting a desired longitudinal deceleration or longitudinal acceleration in a vehicle, in which—at vehicle longitudinal speeds above a limiting value, a first mode is used and—at vehicle longitudinal speeds below the limiting value, a second mode is used.

### FIELD OF THE INVENTION

The present invention relates to a method and a device for setting a desired longitudinal deceleration or longitudinal acceleration in a vehicle.

### BACKGROUND INFORMATION

A method and a device for establishing a vehicle reference speed of an all-wheel drive vehicle are described in German Patent Application No. DE 199 39 979 A1, the vehicle reference speed being established from one or more wheel speeds. A vehicle longitudinal acceleration is established simultaneously from the wheel speeds.

### SUMMARY

The present invention relates to a method for setting a desired longitudinal deceleration a_setpoint or a desired longitudinal acceleration a_setpoint in a vehicle, in which

1. at vehicle longitudinal speeds above a limiting value v0, a first mode (and/or a first method) is used and

2. at vehicle longitudinal speeds below limiting value v0, a second mode (and/or a second method) is used.

An advantage of the present invention is that by applying different methods in different speed ranges, a method tailored to the speed range may be used in each case.

An advantageous embodiment is characterized in that in the first mode, actual longitudinal deceleration (and/or actual longitudinal acceleration) a actual is established on the basis of the wheel speed of at least one wheel. The actual longitudinal deceleration or the actual longitudinal acceleration is varied until it corresponds to desired setpoint longitudinal deceleration a_setpoint or desired setpoint longitudinal acceleration a_setpoint, respectively.

A further advantageous embodiment is characterized in that in the second mode, to set the desired longitudinal deceleration

1. a setpoint brake pressure is established for at least one wheel brake cylinder and

2. the desired longitudinal deceleration is set on the basis of this established setpoint brake pressure.

The advantage of this embodiment at low speeds (below a limiting value v0) is that establishing the wheel speeds via wheel speed sensors is frequently no longer very precise at low speeds. For this reason, it is advantageous to use the brake pressure to establish the longitudinal deceleration.

A further advantageous embodiment is characterized in that the actual brake pressure of the at least one wheel brake cylinder is established and this actual brake pressure is varied until it corresponds to the setpoint brake pressure. The setpoint brake pressure is the brake pressure which leads to the desired vehicle longitudinal deceleration. By adapting the actual brake pressure to this desired setpoint brake pressure, the desired vehicle behavior is achieved.

A further advantageous embodiment is that the setpoint brake pressure is established from information and at least one part of the information is established in an operating state of the vehicle in which the vehicle longitudinal speed is greater than limiting value v0. At high speeds (speeds greater than v0 in particular), the wheel speed sensors provide a very reliable ability to calculate a longitudinal deceleration or a longitudinal acceleration. Information collected in this operating state may then be advantageously analyzed in an operating state following later, in which the vehicle longitudinal speed is less than limiting value v0.

An advantageous embodiment is that during operating states of the vehicle in which the vehicle longitudinal speed is greater than limiting value v0, the present longitudinal deceleration and present brake pressure are detected at least at one point in time. In the present operating state, the setpoint brake pressure is established on the basis of this detected data and the desired longitudinal deceleration.

A further advantageous embodiment is characterized in that the operating states of the vehicle in which the vehicle longitudinal speed is greater than limiting value v0 and in which the present longitudinal deceleration and present brake pressure are detected are distinguished in that the road surface has no significant inclination in the direction of travel. In such operating states, it is especially simple to establish a connection between the vehicle longitudinal deceleration and the brake pressure.

The same method which was applied for the vehicle longitudinal deceleration may also be applied for the longitudinal acceleration. Therefore, an advantageous embodiment is characterized in that in the second mode, to set desired longitudinal acceleration a_setpoint

1. a setpoint engine torque M_setpoint is established and

2. the desired longitudinal deceleration is set on the basis of this established setpoint engine torque.

An advantageous embodiment is characterized in that

1. an actual engine torque is established and

2. the actual engine torque is varied until it corresponds to the setpoint engine torque.

It is advantageous if the setpoint engine torque is established from information and if at least one part of the information was established in an operating state of the vehicle in which the vehicle longitudinal speed was greater than the limiting value.

An advantageous embodiment is that during operating states of the vehicle in which the vehicle longitudinal speed is greater than limiting value v0, the present longitudinal deceleration and present engine torque are detected at least at one point in time and in the present operating state the setpoint engine torque is established on the basis of this detected data and the desired longitudinal acceleration.

It is advantageous if the operating states of the vehicle in which the vehicle longitudinal speed is greater than limiting value v0 and in which the present longitudinal acceleration and present engine torque are detected are distinguished in that the road surface has no significant inclination in the direction of travel.

A device according to the present invention for setting a desired longitudinal deceleration or longitudinal acceleration in a vehicle contains first arrangement to perform a first method (and/or first mode) at vehicle longitudinal speeds above a limiting value v0 and second arrangement perform a second method (and/or second mode) at vehicle longitudinal speeds below limiting value v0.

### BRIEF DESCRIPTION OF THE DRAWINGS

An exemplary embodiment of the present invention is shown in the following figures.

FIG. 1 shows a sequence of an example method according to the present invention for speeds above limiting speed v0 as a control engineering block diagram.

FIG. 2 shows a sequence of an example method according to the present invention for speeds below limiting speed v0 as a control engineering block diagram.

FIG. 3 shows a connection between brake pressure and vehicle longitudinal deceleration in a diagram.

FIG. 4 shows the structure of an example device according to the present invention.

### DETAILED DESCRIPTION OF EXAMPLE EMBODIMENTS

At low vehicle speeds (e.g., below v0=5 km/h), the vehicle deceleration may only be established very imprecisely from the wheel speeds. This is also true for the vehicle longitudinal acceleration. The reason for this is that at low speeds, the rotor of the wheel speed sensor only rotates very slowly and therefore very strong quantization effects come into play due to the number of teeth on the rotor.

Therefore, it is advantageous to use the brake pressure as the controlled variable at low speeds. This brake pressure (in a selected wheel brake cylinder, for example) is available as an estimated variable in ESP systems or as a measured variable in vehicles equipped with electrohydraulic brakes. The brake pressure is also used as the setpoint variable at low speeds. At higher speeds (v>v0), the preset setpoint deceleration is adjusted from the wheel speeds, as before, and the known advantages are thus exploited.

At low speeds, as noted, a precise actual deceleration may no longer be established from the wheel speeds. Oscillations thus arise in the adjusted longitudinal acceleration or longitudinal deceleration. Therefore, detectable oscillations in the deceleration are avoided at low vehicle speeds by regulating to a preset setpoint pressure. The transition between the regulation strategies may be smoothed through adaptive variables. These may be understood to include, for example, averaging of the deceleration or acceleration values obtained using both strategies.

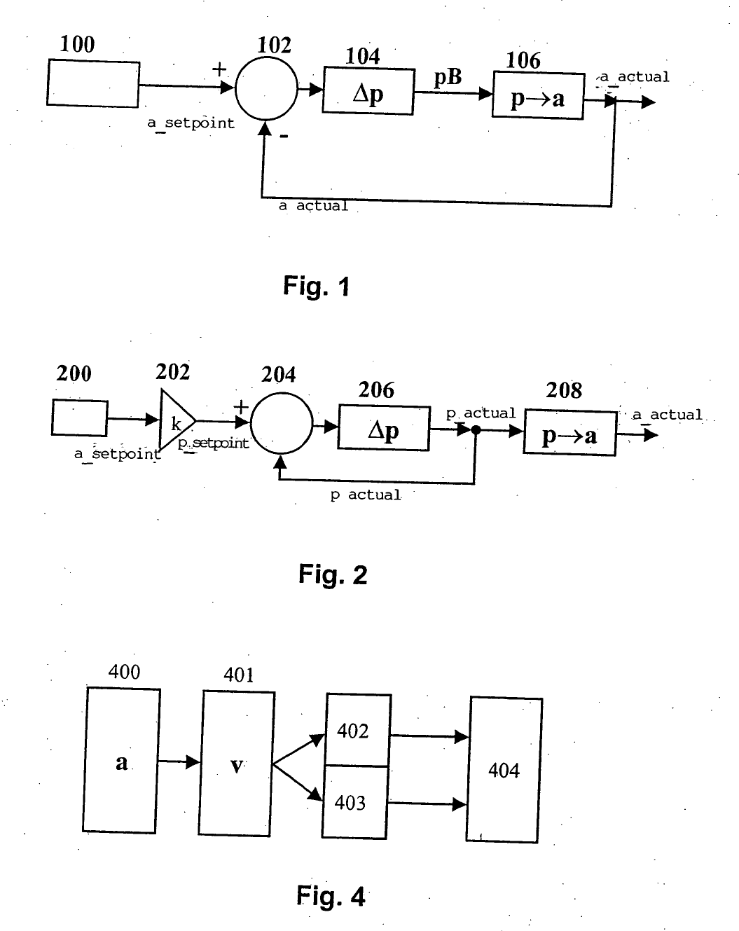

In FIG. 1, the structure of the regulation at high speeds (v>v0) is shown. In block 100, the preset setpoint longitudinal deceleration a_setpoint is preset. This may be established in an ACC system (ACC=“adaptive cruise control”), for example. This signal is fed to logic block 102. In block 102, the difference between preset setpoint longitudinal deceleration a_setpoint and present actual longitudinal deceleration a_actual is calculated. The output signal of block 102 is relayed to block 104, and in block 104, brake pressure pB is varied by value Δp. If a_actual>a_setpoint (the vehicle is braked too strongly), the brake pressure is lowered, and if a_actual<a_setpoint (the vehicle is braked too weakly), the brake pressure is increased. Brake pressure pB is provided by block 104 as the output signal which is applied to the vehicle brakes of vehicle 106. Block 106 describes the vehicle, which represents the controlled system in this case. Brake pressure pB is converted into longitudinal deceleration a_actual therein. Block 106 provides longitudinal deceleration a_actual as the output signal and feeds it back to block 102 for the regulation.

This method is described for the case of braking on the basis of the longitudinal deceleration. It is simple to expand it to the case of acceleration on the basis of the engine torque by varying the engine torque by value ΔM in block 104. The output signal of block 104 is engine torque M_engine in this case.

The sequence of the method for lower speeds is shown in FIG. 2. Block 200 also provides desired output signal a_setpoint here. This output signal a_setpoint is converted into a brake pressure p_setpoint using an amplification factor k in block 202. Brake pressure p_setpoint is to be understood in this case as the pressure which is to result in desired longitudinal deceleration a_setpoint. The amplification factor necessary for the conversion results in this case from the previous history of the driving behavior of the vehicle. At high vehicle speeds (in which the method according to FIG. 1 runs) the connection between the present brake pressure and the present longitudinal deceleration is established and stored at regular or irregular intervals in time. In order to obtain a unique assignment, in particular, only driving states in which the road surface has no significant inclination in the direction of travel are to be taken into consideration. In this way, a table and/or characteristic curve is finally obtained which contains an assignment of the setpoint brake pressure to the setpoint acceleration (and/or the setpoint engine torque to the setpoint deceleration).

It is also possible to detect the inclination of the road surface at high speeds as well. In this way, a separate table and/or characteristic curve is obtained for each road surface inclination.

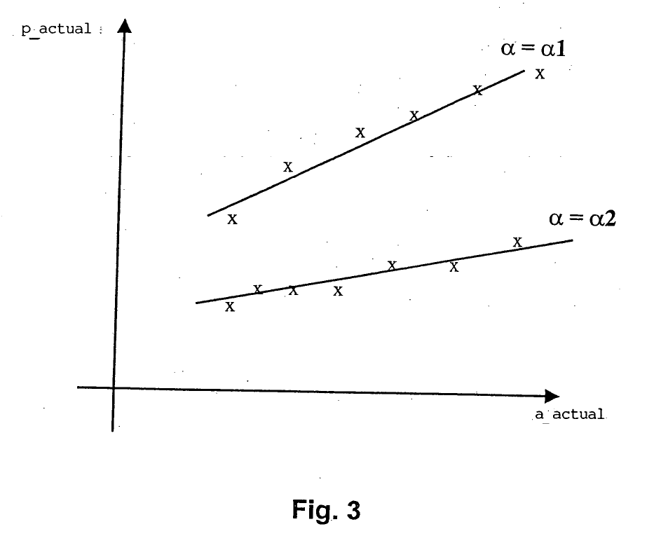

Amplification factor k in block 202 is established from these characteristic curves by interpolation and/or extrapolation. Such a characteristic curve is shown in FIG. 3. In FIG. 3, established present longitudinal deceleration a_actual (at speeds>v0) is plotted on the abscissa and present brake pressure p_actual is plotted on the ordinate. Some established points which were established for two different road surface longitudinal inclinations α (α1 and α2) are plotted.

For driving states at lower speeds, it may now be queried on the basis of these characteristic curves which brake pressure is necessary in order to achieve a desired longitudinal deceleration.

In the method according to the present invention, the property that the brake pressure and the vehicle deceleration resulting therefrom are linked to one another generally via Newton's second law of motion F=m * a is exploited. The vehicle longitudinal speed does not enter into this relationship, i.e., a preset braking force generates a longitudinal deceleration which is generally independent of the vehicle speed.

At low vehicle speeds, variable a_actual is not available directly, since establishing this variable via the wheel speeds is unreliable. For this reason, the output signal of block 202, specifically the setpoint brake pressure, is fed to block 204 in FIG. 2. Block 204 is a logic block which calculates the difference between setpoint brake pressure p_setpoint and actual brake pressure p_actual.

The output signal of block 204 is fed to block 206. In block 206, the system deviation between p_setpoint and p_actual is established and fed to the vehicle in block 208. The output signal of block 206 forms variable p_actual. Variable p_actual is simultaneously fed back to block 204. Block 208 represents the vehicle, in which brake pressure p_actual is converted into a longitudinal acceleration a_actual.

Output signal p_actual of block 206 may either be estimated (in a vehicle dynamics control system, for example) or established (in a vehicle equipped with an electrohydraulic brake (EHB)).

The structure of the device according to the present invention is shown in FIG. 4. In this case, for example, block 400 represents a vehicle dynamics control system and/or an ACC system which presets a desired vehicle longitudinal acceleration or a desired vehicle longitudinal deceleration. The output signal of block 400 is relayed to block 401. The vehicle longitudinal speed is established in block 401. In the case of a low vehicle speed, the output signal from block 401 is fed to block 403, and in the case of a high vehicle longitudinal speed, it is fed to block 402. In this case, different methods are executed in each block for setting the desired longitudinal deceleration and/or the desired longitudinal acceleration. The output signals of block 402 and 403 are fed to actuator block 404. Block 404 contains a braking system or the engine control unit, for example.

1-13. (canceled)

14. A method for setting a desired longitudinal deceleration or longitudinal acceleration in a vehicle, comprising:
setting the desired longitudinal deceleration or longitudinal acceleration using a first mode at vehicle longitudinal speeds above a limiting value; and
setting the desired longitudinal deceleration or longitudinal acceleration using a second mode at vehicle longitudinal speeds below the limiting value.

15. The method as recited in claim 14, wherein the first mode includes:
establishing, on the basis of a wheel speed of at least one wheel, one of an actual longitudinal deceleration or an actual longitudinal acceleration;
varying the at least one of the actual longitudinal deceleration or the actual longitudinal acceleration until it corresponds to a desired longitudinal deceleration or a desired longitudinal acceleration, respectively.

16. The method as recited in claim 14, wherein in the second mode a desired longitudinal deceleration is set by establishing a setpoint brake pressure for at lest one wheel brake cylinder, and setting the desired longitudinal deceleration based on the established setpoint brake pressure.

17. The method as recited in claim 16, wherein the establishing of the desired longitudinal deceleration further comprises:
establishing an actual brake pressure of the at lest one wheel brake cylinder; and
varying the actual brake pressure until the actual brake pressure corresponds to the setpoint brake pressure.

18. The method as recited in claim 17, wherein the setpoint brake pressure is established from information and at least one part of the information is established in an operating state of the vehicle in which the vehicle longitudinal speed is greater than the limiting value (v0).

19. The method as recited in claim 18, wherein during an operating state of the vehicle in which the vehicle longitudinal speed is greater than the limiting value, an actual longitudinal deceleration and the actual brake pressure are detected at least at one point in time, and in the operating state, the setpoint brake pressure is established on the basis of the detected actual longitudinal deceleration, the actual brake pressure, and the desired longitudinal deceleration.

20. The method as recited in claim 19, wherein the operating state of the vehicle in which the vehicle longitudinal speed is greater than the limiting value and in which the actual longitudinal deceleration and actual brake pressure are detected are distinguished in that a road surface has no significant inclination in a direction of travel.

21. The method as recited in claim 14, wherein in the second mode, a desired longitudinal acceleration is set by:
establishing a setpoint engine torque; and
setting the desired longitudinal acceleration based on the established setpoint engine torque.

22. The method as recited in claim 21, wherein the setting of the desired longitudinal acceleration further includes:
establishing an actual engine torque; and
varying the actual engine torque until the actual engine torque corresponds to the setpoint engine torque.

23. The method as recited in claim 22, wherein the setpoint engine torque is established from information and at least one part of the information is established in an operating state of the vehicle in which the vehicle longitudinal speed is greater than the limiting value.

24. The method as recited in claim 23, wherein during an operating state of the vehicle in which the vehicle longitudinal speed is greater than the limiting value, and actual longitudinal acceleration and the actual engine torque are detected at least at one point in time, and in the operating state, the setpoint engine torque is established based on the detected actual longitudinal acceleration, the actual engine torque and the desired longitudinal acceleration.

25. The method as recited in claim 24, wherein the operating state of the vehicle in which the vehicle longitudinal speed is greater than the limiting value and in which the actual longitudinal acceleration and actual engine torque are detected are distinguished in that a road surface has no significant inclination in a direction of travel.

26. A device for setting a desired longitudinal deceleration or longitudinal acceleration in a vehicle, comprising:
a first arrangement configured to perform a first method for setting the desired longitudinal deceleration or longitudinal acceleration, at vehicle longitudinal speeds above a limiting value; and
a second arrangement configured to perform a second method for setting the desired longitudinal deceleration or longitudinal acceleration, at vehicle longitudinal speeds below the limiting value.
